(19) United States
(12) Patent Application Publication
(10) Pub. No.: US 2022/0414643 A1
(43) Pub. Date: Dec. 29, 2022

(54) PAYMENT PROCESSING SYSTEM AND METHOD

(71) Applicant: NETSUNION CLEARING CORPORATION, Beijing (CN)

(72) Inventor: Lingbin KONG, Beijing (CN)

(21) Appl. No.: 17/771,749

(22) PCT Filed: Oct. 23, 2020
(86) PCT No.: PCT/CN2020/123081

§ 371 Date: Apr. 25, 2022

(30) Foreign Application Priority Data
Oct. 25, 2019 (CN) 201911022978.7

(51) Int. Cl. G06Q 20/32; G06Q 20/10; G06Q 20/38; G06Q 20/42

(52) U.S. Cl. CPC G06Q 20/3276; G06Q 20/10; G06Q 20/389; G06Q 20/42

(57) ABSTRACT

A payment processing system includes a user terminal, a merchant terminal, an account institution, a settlement institution and an acquiring institution. The user terminal is configured to send transaction information; the account institution is configured to generate a transaction order and send it to the settlement institution, and the settlement institution is configured to forward it to the acquiring institution; the acquiring institution is configured to process the transaction order and send the order processing result to the settlement institution, and the settlement institution is configured to forward the result to the account institution; the account institution is configured to deduct user funds according to the result and send payment result notification information to the settlement institution, and the settlement institution is configured to forward the notification to the acquiring institution; and the acquiring institution is configured to send a payment result to the merchant terminal.

### CROSS-REFERENCE TO RELATED APPLICATIONS

This application claims priority to Chinese Patent Application No. 201911022978.7 filed on Oct. 25, 2019 by Netsunion Clearing Corporation and titled with “payment processing system and payment processing method”.

### TECHNICAL FIELD

The disclosure relates to the field of Internet technologies, and specifically to a payment processing system and a payment processing method.

### BACKGROUND

At present, with the continuous development of Internet and terminal technologies, barcode payment has become a common payment manner for users.

In the related art, a user terminal scans a code and then jumps to a merchant page, but information displayed on the merchant page may not be unified, thus there are security problems. Also, a transaction jumps back and forth through the Internet environment within an application of an account institution of the user terminal, resulting in a high payment failure rate and a low payment processing efficiency.

### SUMMARY

The disclosure seeks to solve at least one of the problems existing in the related art to at least some extent.

The disclosure provides a payment processing system and a payment processing method, to solve the problems of low payment security, high payment failure rate and low payment processing efficiency in the related art when the user terminal performs the jump after scanning the code and the information displayed on the merchant page may not be unified. The background interaction among the account institution, the settlement institution and the acquiring institution may prevent the security problems caused by the jump of payment processing in the Internet environment and improve the payment processing efficiency.

According to a first aspect of embodiments of the disclosure, a payment processing system is provided. The system includes a user terminal, a merchant terminal, an account institution, a settlement institution and an acquiring institution.

The user terminal is configured to obtain transaction information and send the transaction information to the account institution.

The account institution is configured to generate a transaction order according to the transaction information and send the transaction order to the settlement institution, and the settlement institution is configured to forward the transaction order to the acquiring institution.

The acquiring institution is configured to process the transaction order to generate an order processing result and send the order processing result to the settlement institution, and the settlement institution is configured to forward the order processing result to the account institution.

The account institution is configured to deduct user funds according to the order processing result and send payment result notification information to the settlement institution, and the settlement institution is configured to forward the payment result notification information to the acquiring institution.

The acquiring institution is configured to send a payment result to the merchant terminal according to the payment result notification information, and the merchant terminal is configured to display the payment result.

As a first possible implementation in embodiments of the disclosure, the user terminal is configured to obtain the transaction information and send the transaction information to the account institution by acts of:

reading, by a payment application of the user terminal, a merchant code to generate a payment interface; and

obtaining, by the payment application, a payment amount through the payment interface, and sending, by the payment application, the payment amount, to the account institution.

As a second possible implementation in embodiments of the disclosure, before reading, by the payment application of the user terminal,

the merchant code to generate the payment interface, the merchant terminal is configured to send a payment request to the acquiring institution; and

the acquiring institution is configured to generate the merchant code according to the payment request and send the merchant code to the merchant terminal, and display the merchant code on the merchant terminal.

With the payment processing system according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

According to a second aspect of embodiments of the disclosure, a payment processing method is provided. The method includes:

obtaining, by a user terminal, transaction information, and sending, by the user terminal, the transaction information to an account institution;

generating, by the account institution, a transaction order according to the transaction information, and sending, by the account institution, the transaction order to a settlement institution, and forwarding, by the settlement institution, the transaction order to an acquiring institution;

processing, by the acquiring institution, the transaction order to generate an order processing result, and sending, by the acquiring institution, the order processing result to the settlement institution, and forwarding, by the settlement institution, the order processing result to the account institution;

deducting, by the account institution, user funds according to the order processing result, and sending, by the account institution, payment result notification information to the settlement institution, and forwarding, by the settlement institution, the payment result notification information to the acquiring institution;

sending, by the acquiring institution, a payment result to the merchant terminal according to the payment result notification information, and displaying, by the merchant terminal, the payment result.

As a first possible implementation in embodiments of the disclosure, obtaining, by the user terminal, the transaction information, and sending, by the user terminal, the transaction information to the account institution, includes:

reading, by a payment application of the user terminal, a merchant code to generate a payment interface; and

obtaining, by the payment application, a payment amount through the payment interface, and sending, by the payment application, the payment amount, to the account institution.

As a second possible implementation in embodiments of the disclosure, before reading, by the payment application of the user terminal, the merchant code to generate the payment interface, the method further includes:

sending, by the merchant terminal, a payment request to the acquiring institution; and

generating, by the acquiring institution, the merchant code according to the payment request, and sending, by the acquiring institution, the merchant code to the merchant terminal, and displaying, by the merchant terminal, the merchant code on the merchant terminal.

With the payment processing method according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

According to a third aspect of embodiments of the disclosure, a payment processing device is provided. The device includes:

a sending module, configured to obtain, by a user terminal, transaction information, and send, by the user terminal, the transaction information to an account institution;

a generating and forwarding module, configured to generate, by the account institution, a transaction order according to the transaction information, and send, by the account institution, the transaction order to a settlement institution, and forward, by the settlement institution, the transaction order to an acquiring institution;

a processing and generating module, configured to process, by the acquiring institution, the transaction order to generate an order processing result, and send, by the acquiring institution, the order processing result to the settlement institution, and forward, by the settlement institution, the order processing result to the account institution;

a settlement and sending module, configured to deduct, by the account institution, user funds according to the order processing result, and send, by the account institution, payment result notification information to the settlement institution, and forward, by the settlement institution, the payment result notification information to the acquiring institution; and

a sending and displaying module, configured to send, by the acquiring institution, a payment result to the merchant terminal according to the payment result notification information, and display, by the merchant terminal, the payment result.

As a first possible implementation in embodiments of the disclosure, the sending module is configured to:

read, by a payment application of the user terminal, a merchant code to generate a payment interface; and

obtain, by the payment application, a payment amount through the payment interface, and send, by the payment application, the payment amount, to the account institution.

With the payment processing device according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

According to a fourth aspect of embodiments of the disclosure, a payment processing method is provided. The method, for a settlement institution, includes: receiving a transaction order from an account institution, the transaction order being generated by the account institution according to transaction information from a user terminal; forwarding the transaction order to an acquiring institution for the acquiring institution to process the transaction order to generate an order processing result; obtaining the order processing result sent by the acquiring institution, and forwarding the order processing result to the account institution for the account institution to deduct user funds according to the order processing result to generate payment result notification information; obtaining the payment result notification information sent by the account institution, and forwarding the payment result notification information to the acquiring institution, so that the acquiring institution sends a payment result to the merchant terminal according to the payment result notification information.

With the payment processing method according to embodiments of the disclosure, the account institution generates a transaction order according to the transaction information and sends the transaction order to the settlement institution, and the settlement institution forwards the transaction order to the acquiring institution; the settlement institution forwards the order processing result to the account institution, in which the acquiring institution processes the transaction order to generate the order processing result and sends the order processing result to the settlement institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information. Therefore, through the background interaction among the account institution, the settlement institution and the acquiring institution, it may prevent the security problems caused by the jump of payment processing in the Internet environment, shorten payment processing links and improve the payment processing efficiency.

According to a fifth aspect of embodiments of the disclosure, a payment processing device is provided. The device, for a settlement institution, includes: a receiving module, configured to receive a transaction order from an account institution, the transaction order being generated by the account institution according to transaction information from a user terminal; a first forwarding module, configured to forward the transaction order to an acquiring institution for the acquiring institution to process the transaction order to generate an order processing result; a second forwarding module, configured to obtain the order processing result sent by the acquiring institution, and forward the order processing result to the account institution for the account institution to deduct user funds according to the order processing result to generate payment result notification information; a third forwarding module, configured to obtain the payment result notification information sent by the account institution, and forward the payment result notification information to the acquiring institution, so that the acquiring institution sends a payment result to the merchant terminal according to the payment result notification information.

With the payment processing device according to embodiments of the disclosure, the account institution generates a transaction order according to the transaction information and sends the transaction order to the settlement institution, and the settlement institution forwards the transaction order to the acquiring institution; the settlement institution forwards the order processing result to the account institution, in which the acquiring institution processes the transaction order to generate the order processing result and sends the order processing result to the settlement institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information. Therefore, through the background interaction among the account institution, the settlement institution and the acquiring institution, it may prevent the security problems caused by the jump of payment processing in the Internet environment, shorten payment processing links and improve the payment processing efficiency.

According to a sixth aspect of embodiments of the disclosure, a computer device is provided and includes: a memory, a processor and a computer program stored in the memory and executable by the processor. When the computer program is performed by a processor, the method as described above is realized.

According to a seventh aspect of embodiments of the disclosure, a non-transitory computer-readable storage medium stored with a computer program is provided. When the computer program is performed by a processor, the method as described above is realized.

Additional aspects and advantages of embodiments of the disclosure will be given in part in the following descriptions, become apparent in part from the following descriptions, or be learned from the practice of the embodiments of the disclosure.

### BRIEF DESCRIPTION OF THE DRAWINGS

FIG. 1 is a schematic structural diagram of a payment processing system according to an embodiment of the disclosure.

FIG. 2 is an example diagram of payment processing according to an embodiment of the disclosure.

FIG. 3 is an example diagram of payment processing according to another embodiment of the disclosure.

FIG. 4 is an example diagram of a payment processing method according to an embodiment of the disclosure.

FIG. 5 is a schematic structural diagram of a payment processing device according to an embodiment of the disclosure.

FIG. 6 is an example diagram of a payment processing method according to another embodiment of the disclosure.

FIG. 7 is a schematic structural diagram of a payment processing device according to another embodiment of the disclosure.

### DETAILED DESCRIPTION

Reference will now be made in detail to embodiments of the disclosure, examples of which are illustrated in the drawings, in which the same or similar elements and the elements having same or similar functions are denoted by like reference numerals throughout the descriptions.

The embodiments described herein with reference to the drawings are illustrative, used to generally understand the disclosure, and shall not be construed to limit the disclosure.

The following describes a payment processing system and a payment processing method according to embodiments of the disclosure with reference to the drawings.

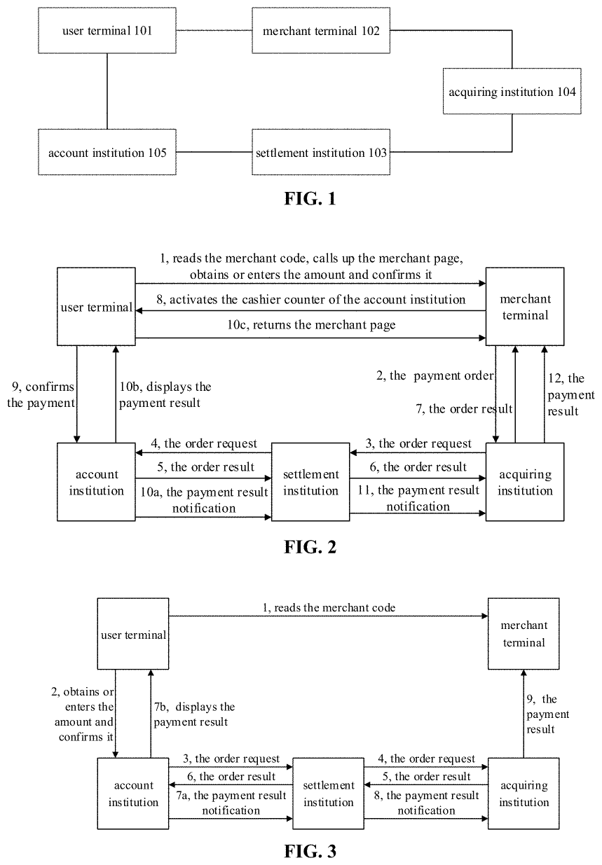

FIG. 1 is a schematic structural diagram of a payment processing system according to an embodiment of the disclosure.

As shown in FIG. 1, the payment processing system includes a user terminal 101, a merchant terminal 102, a settlement institution 103, an acquiring institution 104 and an account institution 105.

The user terminal 101 obtains transaction information and sends the transaction information to the account institution 105.

The account institution 105 generates a transaction order according to the transaction information and sends the transaction order to the settlement institution 103, and the settlement institution 103 forwards the transaction order to the acquiring institution 104.

The acquiring institution 104 processes the transaction order to generates an order processing result and sends the order processing result to the settlement institution 103, and the settlement institution 103 forwards the order processing result to the account institution 105.

The account institution 105 deducts user funds according to the order processing result, and sends payment result notification information to the settlement institution 103, and the settlement institution 103 forwards the payment result notification information to the acquiring institution 104.

The acquiring institution 104 sends a payment result to the merchant terminal 102 according to the payment result notification information, and the payment result is displayed on the merchant terminal 102.

In detail, participants of the barcode payment include the user terminal 101 (that is, the payer), the merchant terminal 102 (that is, the payee), the acquiring institution 104, the account institution 105 and the settlement institution 103. The user establishes an account at the account institution 105. An account institution barcode payment application of the user terminal 101 reads the barcode displayed by the merchant to make the payment. The merchant terminal 102 uses the barcode acquiring service provided by the acquiring institution to accept users to complete transactions through various barcode payment products. The acquiring institution 104 is responsible for signing, accessing and daily management of merchants, providing and maintaining barcode acceptance terminals, merchant code cards, etc., receiving and processing barcode payment instructions forwarded by the settlement institution 103, and handling merchant acquiring fund settlement. The account institution 105 is responsible for user account establishing and providing account services, receiving and processing barcode payment instructions forwarded by the settlement institution 103, and handling user fund settlement. The settlement institution 103 is responsible for receiving and processing barcode payment instructions, settlement of transaction funds, and playing a role of transaction transfer and fund settlement in the barcode payment services.

In view of the above description, the behavior in which the user uses the account institution barcode payment application of the user terminal to read the merchant code displayed by the barcode payment acceptance terminal of the merchant or the merchant code displayed on the merchant code card (i.e., the user scans the merchant code) to make a payment, is usually referred to as “payment and scanning code”, as shown in FIG. 2.

Specifically, the account institution barcode payment application of the user terminal 101 reads the merchant code and calls up the merchant page. The user obtains or enters the amount of the purchased product on the merchant page and confirms it. The merchant background system generates the payment order and submits it to the acquiring institution 104. The acquiring institution 104 calls the order interface and submits the order request to the settlement institution 103. The settlement institution 103 receives the order request and forwards it to the account institution 105. The account institution 105 receives the order request forwarded by the settlement institution 103 and completes the order processing and returns the order result to the settlement institution 103. The settlement institution 103 receives the order result and forwards it to the acquiring institution 104. The acquiring institution 104 receives the order result forwarded by the settlement institution 103 and returns the order result to the merchant background system. The system activates the cashier counter of the account institution application of the user terminal 101. The user confirms the payment at the cashier counter and enters the payment password to confirm the payment if necessary. The account institution 105 completes the deduction of the user funds and sends the barcode payment result notification to the settlement institution 103, and displays the barcode payment result to the user and guides the user back to the merchant page. The settlement institution 103 receives the barcode payment result notification and forwards it to the acquiring institution 104. The acquiring institution 104 receives the barcode payment result notification forwarded by the settlement institution 103 and displays the barcode payment result to the merchant.

In the above solution, the user terminal jumps after scanning the code, the information displayed on the merchant page may not be unified, and the user experience is uneven. If the merchant code card is replaced, it is easy to cause the user to jump to the phishing website, and there is a risk of scanning the code. The transaction jumps back and forth through the Internet environment in the account institution application of the user terminal, which may cause the high payment failure rate (the failure rate increases by about 30% for each jump), and it is easy to be hijacked during the jump process. In addition, the transaction jumps among the user, the merchant, the account institution, the acquiring institution and the settlement institutions multiple times, and the transaction links are too long. After the final transaction is completed and returned to the merchant page, it is easy to be embedded with bad information, advertising pushes, aggregate services and the like.

The payment processing system of the disclosure, through the background interaction among the account institution 105, the settlement institution 103 and the acquiring institution 104, prevents the security problems caused by the jump of payment processing in the Internet environment, shortens payment processing links and improves the payment processing efficiency.

In an embodiment of the disclosure, the user terminal 101 obtains the transaction information and sends the transaction information to the account institution 105, including: reading, by a payment application of the user terminal 101, a merchant code to generate a payment interface; and obtaining, by the payment application, a payment amount through the payment interface, and sending, by the payment application, the payment amount, to the account institution 105.

In order to be more clear about the specific process of the disclosure, as shown in FIG. 3, the account institution barcode payment application of the user terminal 101 reads the merchant code and sends it to the account institution 105. The user obtains or enters the purchase amount in the barcode payment application and confirms it. The account institution 105 generates the order, calls the order interface, and submits the order request to the settlement institution 103. The settlement institution 103 receives the order request and forwards it to the acquiring institution 104, and the acquiring institution 104 receives the order request forwarded by the settlement institution 103, completes the order processing and returns the order result to the settlement institution 103. The settlement institution 103 receives the order result and forwards it to the account institution 105. The account institution 105 completes the deduction of user funds, sends the barcode payment result notification to the settlement institution 103, and displays it to the user. The settlement institution 103 receives the barcode payment result notification and forwards it to the acquiring institution 104. The acquiring institution 104 receives the barcode payment result notification forwarded by the settlement institution 103 and displays the barcode payment result to the merchant.

That is to say, the transaction of the disclosure is transmitted through the background interaction among the acquiring institution, the account institution and the settlement institution. The order is sent by the account institution to the acquiring institution through the settlement institution for confirmation, and the acquiring institution completes the confirmation and returns the confirmation result to the account institution through the settlement institution, and the account institution completes the deduction of user funds. Therefore, the user terminal always stays at the account institution after scanning the code without jumping, and there is no problem of inconsistent information displayed on the merchant page; and if the merchant code card is replaced, the account institution fails to verify the merchant code and considers it to be an invalid barcode, and there is no risk of scanning codes. Transactions are transferred among the account institution, the settlement institution and the acquiring institution through the background interactions. The background interactions are transmitted through dedicated lines. The reliability is high. There is no problem of user hijacking in the Internet environment. The transaction interaction process after scanning the code by the user is executed in the background, skipping the jump process, simplifying the transaction links, and finally there is no problem of bad information, advertising push and traffic realization of aggregation service providers.

It should be noted that the merchant code in the disclosure may be either a static code or a dynamic code. The dynamic code generation instruction is as follows.

The merchant terminal 102 sends a payment request to the acquiring institution 102. The acquiring institution 104 generates the merchant code according to the payment request and send the merchant code to the merchant terminal 102, and display the merchant code on the merchant terminal 102.

With the payment processing system according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

In order to implement the above embodiments, the disclosure also proposes a payment processing method.

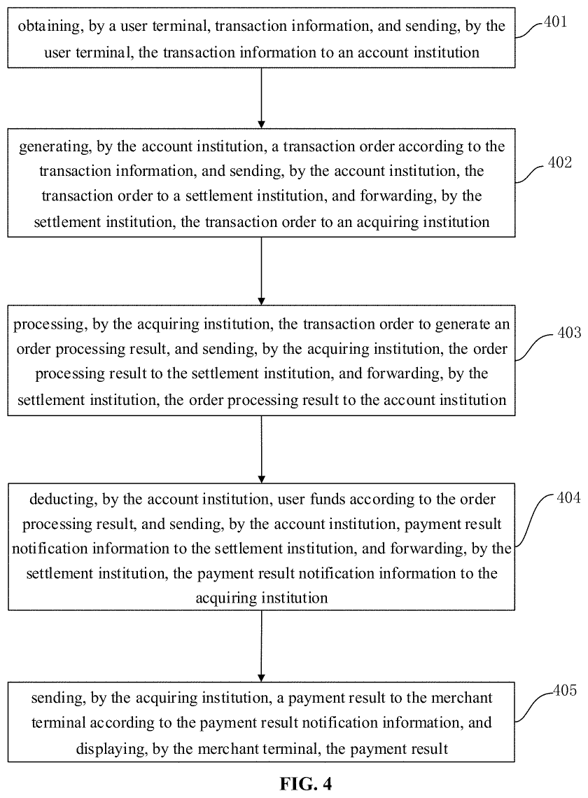

FIG. 4 is an example diagram of a payment processing method according to an embodiment of the disclosure.

As shown in FIG. 4, the payment processing method includes the following step.

Step 401: a user terminal obtains transaction information and sends the transaction information to an account institution.

S402: the account institution generates a transaction order according to the transaction information, and sends the transaction order to a settlement institution, and the settlement institution forwards the transaction order to an acquiring institution.

S403: the acquiring institution processes the transaction order to generate an order processing result, and sends the order processing result to the settlement institution, and the settlement institution forwards the order processing result to the account institution.

S404: the account institution deducts user funds according to the order processing result, and sends payment result notification information to the settlement institution, and the settlement institution forwards the payment result notification information to the acquiring institution.

S405: the acquiring institution sends a payment result to the merchant terminal according to the payment result notification information, and the merchant terminal displays the payment result.

In an embodiment of the disclosure, obtaining, by the user terminal, the transaction information, and sending, by the user terminal, the transaction information to the account institution, includes: reading, by a payment application of the user terminal, a merchant code to generate a payment interface; and obtaining, by the payment application, a payment amount through the payment interface, and sending, by the payment application, the payment amount, to the account institution.

With the payment processing method according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

In order to implement the above embodiments, the disclosure also proposes a payment processing device.

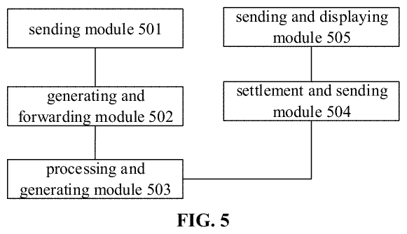

As shown in FIG. 5, the payment processing device includes a sending module 501, a generating and forwarding module 502, a processing and generating module 503, a settlement and sending module 504 and a sending and displaying module 505.

The sending module 501 is configured to obtain, by a user terminal, transaction information, and send, by the user terminal, the transaction information to an account institution.

The generating and forwarding module 502 is configured to generate, by the account institution, a transaction order according to the transaction information, and send, by the account institution, the transaction order to a settlement institution, and forward, by the settlement institution, the transaction order to an acquiring institution.

The processing and generating module 503 is configured to process, by the acquiring institution, the transaction order to generate an order processing result, and send, by the acquiring institution, the order processing result to the settlement institution, and forward, by the settlement institution, the order processing result to the account institution.

The settlement and sending module 504 is configured to deduct, by the account institution, user funds according to the order processing result, and send, by the account institution, payment result notification information to the settlement institution, and forward, by the settlement institution, the payment result notification information to the acquiring institution.

The sending and displaying module 505 is configured to send, by the acquiring institution, a payment result to the merchant terminal according to the payment result notification information, and display, by the merchant terminal, the payment result.

It should be noted that the foregoing explanation of the embodiments of the payment processing method is also applicable to the device of some embodiments, and will not be repeated herein.

With the payment processing device according to embodiments of the disclosure, the user terminal obtains transaction information and sends the transaction information to the account institution; the account institution generates a transaction order according to the transaction information and sends the transaction order to the settlement institution, and the settlement institution forwards the transaction order to the acquiring institution; the acquiring institution processes the transaction order to generate an order processing result and sends the order processing result to the settlement institution, and the settlement institution forwards the order processing result to the account institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information, and the merchant terminal displays the payment result. Therefore, through the background interaction among the account institution, the settlement institution and the acquiring institution, it may prevent the security problems caused by the jump of payment processing in the Internet environment, shorten payment processing links and improve the payment processing efficiency.

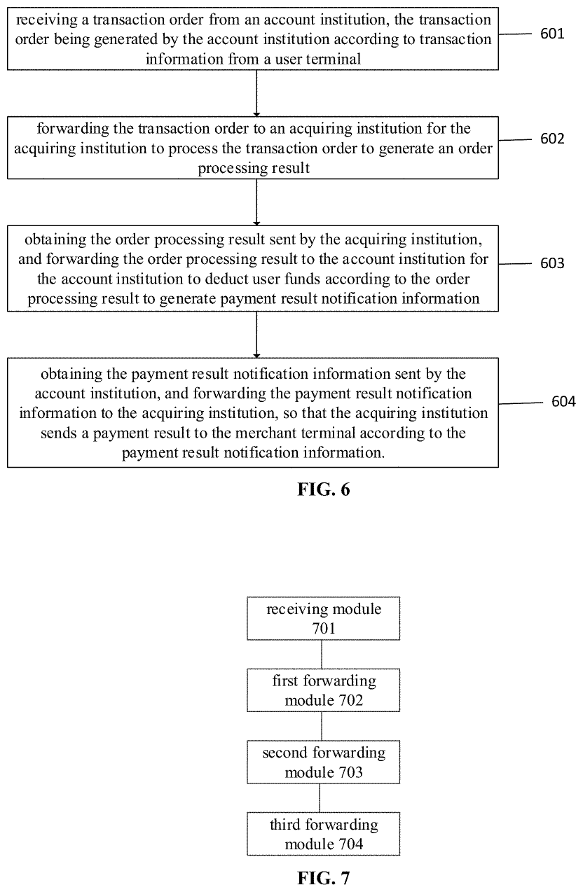

In order to implement the above embodiments, the disclosure also proposes a payment processing method. As shown in FIG. 6, the payment processing method is applied to the settlement institution and includes the following steps.

Step 601: receiving a transaction order from an account institution, the transaction order being generated by the account institution according to transaction information from a user terminal.

Step 602: forwarding the transaction order to an acquiring institution for the acquiring institution to process the transaction order to generate an order processing result.

Step 603: obtaining the order processing result sent by the acquiring institution, and forwarding the order processing result to the account institution for the account institution to deduct user funds according to the order processing result to generate payment result notification information.

Step 604: obtaining the payment result notification information sent by the account institution, and forwarding the payment result notification information to the acquiring institution, so that the acquiring institution sends a payment result to the merchant terminal according to the payment result notification information.

In detail, as shown in FIG. 1, participants of the barcode payment include the user terminal 101 (that is, the payer), the merchant terminal 102 (that is, the payee), the acquiring institution 104, the account institution 105 and the settlement institution 103. The user establishes an account at the account institution 105. An account institution barcode payment application of the user terminal 101 reads the barcode displayed by the merchant to make the payment. The merchant terminal 102 uses the barcode acquiring service provided by the acquiring institution to accept users to complete transactions through various barcode payment products. The acquiring institution 104 is responsible for signing, accessing and daily management of merchants, providing and maintaining barcode acceptance terminals, merchant code cards, etc., receiving and processing barcode payment instructions forwarded by the settlement institution 103, and handling merchant acquiring fund settlement.

The account institution 105 is responsible for user account establishing and providing account services, receiving and processing barcode payment instructions forwarded by the settlement institution 103, and handling user fund settlement. The settlement institution 103 is responsible for receiving and processing barcode payment instructions, settlement of transaction funds, and playing a role of transaction transfer and fund settlement in the barcode payment services.

In view of the above description, the behavior in which the user uses the account institution barcode payment application of the user terminal to read the merchant code displayed by the barcode payment acceptance terminal of the merchant or the merchant code displayed on the merchant code card (i.e., the user scans the merchant code) to make a payment, is usually referred to as “payment and scanning code”, as shown in FIG. 2.

Specifically, the account institution barcode payment application of the user terminal 101 reads the merchant code and calls up the merchant page. The user obtains or enters the amount of the purchased product on the merchant page and confirms it. The merchant background system generates the payment order and submits it to the acquiring institution 104. The acquiring institution 104 calls the order interface and submits the order request to the settlement institution 103. The settlement institution 103 receives the order request and forwards it to the account institution 105. The account institution 105 receives the order request forwarded by the settlement institution 103 and completes the order processing and returns the order result to the settlement institution 103. The settlement institution 103 receives the order result and forwards it to the acquiring institution 104. The acquiring institution 104 receives the order result forwarded by the settlement institution 103 and returns the order result to the merchant background system. The system activates the cashier counter of the account institution application of the user terminal 101. The user confirms the payment at the cashier counter and enters the payment password to confirm the payment if necessary. The account institution 105 completes the deduction of the user funds and sends the barcode payment result notification to the settlement institution 103, and displays the barcode payment result to the user and guides the user back to the merchant page. The settlement institution 103 receives the barcode payment result notification and forwards it to the acquiring institution 104. The acquiring institution 104 receives the barcode payment result notification forwarded by the settlement institution 103 and displays the barcode payment result to the merchant.

In the above solution, the user terminal jumps after scanning the code, the information displayed on the merchant page may not be unified, and the user experience is uneven. If the merchant code card is replaced, it is easy to cause the user to jump to the phishing website, and there is a risk of scanning the code. The transaction jumps back and forth through the Internet environment in the account institution application of the user terminal, which may cause the high payment failure rate (the failure rate increases by about 30% for each jump), and it is easy to be hijacked during the jump process. In addition, the transaction jumps among the user, the merchant, the account institution, the acquiring institution and the settlement institutions multiple times, and the transaction links are too long. After the final transaction is completed and returned to the merchant page, it is easy to be embedded with bad information, advertising pushes, aggregate services and the like.

In an embodiment of the disclosure, as shown in FIG. 3, the account institution barcode payment application of the user terminal 101 reads the merchant code and sends it to the account institution 105. The user obtains or enters the purchase amount in the barcode payment application and confirms it. The account institution 105 generates the order, calls the order interface, and submits the order request to the settlement institution 103. The settlement institution 103 receives the order request and forwards it to the acquiring institution 104, and the acquiring institution 104 receives the order request forwarded by the settlement institution 103, completes the order processing and returns the order result to the settlement institution 103. The settlement institution 103 receives the order result and forwards it to the account institution 105. The account institution 105 completes the deduction of user funds, sends the barcode payment result notification to the settlement institution 103, and displays it to the user. The settlement institution 103 receives the barcode payment result notification and forwards it to the acquiring institution 104. The acquiring institution 104 receives the barcode payment result notification forwarded by the settlement institution 103 and displays the barcode payment result to the merchant.

That is to say, the transaction of the disclosure is transmitted through the background interaction among the acquiring institution, the account institution and the settlement institution. The order is sent by the account institution to the acquiring institution through the settlement institution for confirmation, and the acquiring institution completes the confirmation and returns the confirmation result to the account institution through the settlement institution, and the account institution completes the deduction of user funds. Therefore, the user terminal always stays at the account institution after scanning the code without jumping, and there is no problem of inconsistent information displayed on the merchant page; and if the merchant code card is replaced, the account institution fails to verify the merchant code and considers it to be an invalid barcode, and there is no risk of scanning codes. Transactions are transferred among the account institution, the settlement institution and the acquiring institution through the background interactions. The background interactions are transmitted through dedicated lines. The reliability is high. There is no problem of user hijacking in the Internet environment. The transaction interaction process after scanning the code by the user is executed in the background, skipping the jump process, simplifying the transaction links, and finally there is no problem of bad information, advertising push and traffic realization of aggregation service providers.

With the payment processing method according to embodiments of the disclosure, the account institution generates a transaction order according to the transaction information and sends the transaction order to the settlement institution, and the settlement institution forwards the transaction order to the acquiring institution; the settlement institution forwards the order processing result to the account institution, in which the acquiring institution processes the transaction order to generate the order processing result and sends the order processing result to the settlement institution; the account institution deducts user funds according to the order processing result and sends payment result notification information to the settlement institution, and the settlement institution forwards the payment result notification information to the acquiring institution; and the acquiring institution sends a payment result to the merchant terminal according to the payment result notification information. Therefore, through the background interaction among the account institution, the settlement institution and the acquiring institution, it may prevent the security problems caused by the jump of payment processing in the Internet environment, shorten payment processing links and improve the payment processing efficiency.

In order to implement the above embodiments, the disclosure also proposes a payment processing device. As shown in FIG. 7, the payment processing device is applied to the settlement institution side, and includes a receiving module 701, a first forwarding module 702, a second forwarding module 703 and a third forwarding module 704.

The receiving module 701 is configured to receive a transaction order from an account institution, the transaction order being generated by the account institution according to transaction information from a user terminal.

The first forwarding module 702 is configured to forward the transaction order to an acquiring institution for the acquiring institution to process the transaction order to generate an order processing result.

The second forwarding module 703 is configured to obtain the order processing result sent by the acquiring institution, and forward the order processing result to the account institution for the account institution to deduct user funds according to the order processing result to generate payment result notification information.

The third forwarding module 704 is configured to obtain the payment result notification information sent by the account institution, and forward the payment result notification information to the acquiring institution, so that the acquiring institution sends a payment result to the merchant terminal according to the payment result notification information.

It should be noted that the foregoing explanation of the embodiments of the payment processing method is also applicable to the device of some embodiments, and will not be repeated herein.

In order to implement the above embodiments, the disclosure also proposes a computer device, including a memory, a processor, and a computer program stored in the memory and capable of running on the processor. When the processor executes the program, the payment processing method described in the above-mentioned embodiments is implemented.

In order to implement the above embodiments, the disclosure also proposes a non-transitory computer-readable storage medium on which a computer program is stored, and when the program is executed by a processor, the payment processing method as described in the above-mentioned embodiments is implemented.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the disclosure. In this specification, the schematic representations of the above terms do not necessarily refer to the same embodiment or example. Moreover, the described specific features, structures, materials, or characteristics may be combined in any one or more embodiments or examples in a suitable manner. In addition, those skilled in the art may combine the different embodiments or examples and the features of the different embodiments or examples described in this specification without contradicting each other.

In addition, the terms “first” and “second” are only used for descriptive purposes, and may not be understood as indicating or implying relative importance or implicitly indicating the number of indicated technical features. Therefore, the features defined with “first” and “second” may explicitly or implicitly include at least one of the features. In the description of the present application, “a plurality of” means at least two, such as two, three, etc., unless specifically defined otherwise.

Any process or method described in a flow chart or described herein in other ways may be understood to include one or more modules, segments or portions of codes of executable instructions for achieving specific logical functions or steps in the process, and the scope of a preferred embodiment of the disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art.

Those skilled in the art shall understand that all or parts of the steps in the above exemplifying method of the disclosure may be achieved by commanding the related hardware with programs. The programs may be stored in a computer readable storage medium, and the programs comprise one or a combination of the steps in the method embodiments of the disclosure when run on a computer.

In addition, each function cell of the embodiments of the disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

Although explanatory embodiments have been shown and described, it would be appreciated by those skilled in the art that the above embodiments cannot be construed to limit the disclosure, and changes, alternatives, and modifications can be made in the embodiments without departing from spirit, principles and scope of the disclosure.

1. A payment processing system, comprising a user terminal, a merchant terminal, an account institution, a settlement institution and an acquiring institution; wherein,
the user terminal is configured to obtain transaction information and send the transaction information to the account institution;
the account institution is configured to generate a transaction order according to the transaction information and send the transaction order to the settlement institution, and the settlement institution is configured to forward the transaction order to the acquiring institution;
the acquiring institution is configured to process the transaction order to generate an order processing result and send the order processing result to the settlement institution, and the settlement institution is configured to forward the order processing result to the account institution;
the account institution is configured to deduct user funds according to the order processing result and send payment result notification information to the settlement institution, and the settlement institution is configured to forward the payment result notification information to the acquiring institution; and
the acquiring institution is configured to send a payment result to the merchant terminal according to the payment result notification information, and the merchant terminal is configured to display the payment result.

2. The system as claimed in claim 1, wherein the user terminal is configured to obtain the transaction information and send the transaction information to the account institution by acts of:
reading, by a payment application of the user terminal, a merchant code to generate a payment interface; and
obtaining, by the payment application, a payment amount through the payment interface, and sending, by the payment application, the payment amount, to the account institution.

3. The system as claimed in claim 2, before reading, by the payment application of the user terminal, the merchant code to generate the payment interface, wherein:
the merchant terminal is configured to send a payment request to the acquiring institution; and
the acquiring institution is configured to generate the merchant code according to the payment request and send the merchant code to the merchant terminal, and display the merchant code on the merchant terminal.

4. A payment processing method, comprising:
obtaining, by a user terminal, transaction information, and sending, by the user terminal, the transaction information to an account institution;
generating, by the account institution, a transaction order according to the transaction information, and sending, by the account institution, the transaction order to a settlement institution, and forwarding, by the settlement institution, the transaction order to an acquiring institution;
processing, by the acquiring institution, the transaction order to generate an order processing result, and sending, by the acquiring institution, the order processing result to the settlement institution, and forwarding, by the settlement institution, the order processing result to the account institution;
deducting, by the account institution, user funds according to the order processing result, and sending, by the account institution, payment result notification information to the settlement institution, and forwarding, by the settlement institution, the payment result notification information to the acquiring institution; and
sending, by the acquiring institution, a payment result to a merchant terminal according to the payment result notification information, and displaying, by the merchant terminal, the payment result.

5. The method as claimed in claim 4, wherein obtaining, by the user terminal, the transaction information, and sending, by the user terminal, the transaction information to the account institution, comprises:
reading, by a payment application of the user terminal, a merchant code to generate a payment interface; and
obtaining, by the payment application, a payment amount through the payment interface, and sending, by the payment application, the payment amount, to the account institution.

6. The method as claimed in claim 5, before reading, by the payment application of the user terminal, the merchant code to generate the payment interface, further comprising:
sending, by the merchant terminal, a payment request to the acquiring institution; and
generating, by the acquiring institution, the merchant code according to the payment request, and sending, by the acquiring institution, the merchant code to the merchant terminal, and displaying, by the merchant terminal, the merchant code on the merchant terminal.

7.-8. (canceled)

9. A payment processing method, for a settlement institution, comprising:
receiving a transaction order from an account institution, the transaction order being generated by the account institution according to transaction information from a user terminal;
forwarding the transaction order to an acquiring institution for the acquiring institution to process the transaction order to generate an order processing result;
obtaining the order processing result sent by the acquiring institution, and forwarding the order processing result to the account institution for the account institution to deduct user funds according to the order processing result to generate payment result notification information; and
obtaining the payment result notification information sent by the account institution, and forwarding the payment result notification information to the acquiring institution, so that the acquiring institution sends a payment result to a merchant terminal according to the payment result notification information.

10.-12. (canceled)
